(19) United States
(12) Patent Application Publication
(10) Pub. No.: US 2023/0160412 A1
(43) Pub. Date: May 25, 2023

(54) COUPLING ASSEMBLY INCLUDING A SCRIVET FASTENER

(71) Applicant: THE BOEING COMPANY, CHICAGO, IL (US)

(72) Inventors: Joe Louis Hurtado, Easley, SC (US); Maceo Selvestre Fernandez, Los Angeles, CA (US); Al-Michael Lampitoc Franco, Renton, WA (US)

(73) Assignee: THE BOEING COMPANY, CHICAGO, IL (US)

(21) Appl. No.: 17/456,319

(22) Filed: Nov. 23, 2021

(51) Int. Cl. F16B 21/02; F16B 2/22; F16B 5/06

(52) U.S. Cl. CPC F16B 21/02; F16B 2/22; F16B 5/0628; F16B 5/0657; F16B 2005/0671

(57) ABSTRACT

A scrivet fastener for coupling a panel to a mating structure includes a head, a shaft extending from the head to a distal end of the shaft, and a compliant retention flange. The compliant retention flange extends radially outward from the shaft and is axially spaced apart from the head. The scrivet fastener is configured to at least temporarily couple the panel to the mating structure, such that the distal end of the shaft is secured to a hole of the mating structure and the compliant retention flange is secured to a deformable material of the panel.

### FIELD OF THE DISCLOSURE

Embodiments of the present disclosure generally relate to fasteners used to couple two discrete panels or other objects together, at least temporarily.

### BACKGROUND OF THE DISCLOSURE

During the manufacturing of internal cabins of vehicles, fasteners can be used to temporarily secure a floor covering on top of production floor panels. The floor covering may protect the floor panels from impacts, scratches, stains, and the like from tools, equipment, and/or fluids (e.g., oil, paint, etc.) while the internal cabin is manufactured. As one of the finishing steps before completion of the internal cabin, the floor covering is removed to expose the production floor panels.

One conventional fastener used to secure the floor covering to the production floor panels during the manufacturing process is a scrivet fastener 100 as shown in FIG. 1. The scrivet fastener 100 has a shaft 102 and a head 104. The shaft 102 is inserted through a first hole 106 in a cover, or protection, panel 108 such that a portion of the shaft 102 extends into a second hole 110 in a production floor panel 112. Optionally, the production floor panel 112 includes an insert 114 within the second hole 110, and the shaft 102 extends into the insert 114. The head 104 of the scrivet fastener 100 abuts against a top, cabin-facing surface 116 of the cover panel 108 when the scrivet fastener 100 is in a fully loaded position.

One drawback of the conventional scrivet fastener 100 is an ineffectiveness at retaining the cover panel 108 on the production floor panel 112. The shaft 102 of the conventional scrivet fastener 100 has a fluted design with a series of conical features 118 resembling a pine tree. When inserted into the second hole 110 of the production floor panel 112, only the edges of the conical features 118 engage the interior surface of the insert 114, so there is limited surface area of the shaft 102 that contacts the interior surface. Furthermore, the conical features 118 may collapse upon entering the narrow hole. As a result of the limited contact surface area and the deformation of the conical features 118, the fluted design of the shaft 102 provides limited retention of the fastener 100 to the production floor panel 112. For example, weight on the cover panel 108 applied by people walking on the cover panel 108 and/or equipment may cause the cover panel 108 to compress and then decompress when the weight is removed. As the cover panel 108 decompresses, the top surface 116 may force the head 104 of the fastener 100 in a direction away from the floor panel 112 with sufficient magnitude to overcome the limited retention force provided by the shaft 102, causing the fastener 100 to separate from the production floor panel 112.

Furthermore, the conventional scrivet fastener 100 does not secure to the cover panel 108 independent of the production floor panel 112. When the fastener 100 separates from the production floor panel 112, either intentionally or unintentionally, the fastener 100 may fall out of the first hole 106 in the cover panel 108. For example, when the cover panel 108 is lifted off the production floor panel 112 to expose the production floor panel 112, a plurality of the fasteners 100 may fall onto the production floor panel 112 and become debris (e.g., foreign object debris (FOD)). Fastener debris can damage the floor panels (particularly when pressed into the floor panels by equipment, luggage, and/or people walking), can present a tripping hazard, and can increase costs associated with collecting and picking up the loose fasteners and replacing lost fasteners.

### SUMMARY OF THE DISCLOSURE

A need exists for a coupling assembly that includes scrivet fasteners which provide a low cost, simple, and secure means of coupling two objects together, including a panel and a mating structure. A need also exists for scrivet fasteners that can provide increased retention to each of the objects that are coupled together, relative to the conventional scrivet fastener design shown in FIG. 1. As such, the scrivet fasteners would be less likely to unintentionally separate from the mating structure than the conventional scrivet fastener. In the event of the panel being pulled away from the mating structure, the scrivet fasteners would remain on the panel without becoming FOD.

With those needs in mind, certain embodiments of the present disclosure provide a scrivet fastener for coupling a panel to a mating structure. The scrivet fastener includes a head, a shaft extending from the head to a distal end of the shaft, and a compliant retention flange. The compliant retention flange extends radially outward from the shaft and is axially spaced apart from the head. The scrivet fastener is configured to at least temporarily couple the panel to the mating structure, such that the distal end of the shaft is secured to a hole of the mating structure and the compliant retention flange is secured to a deformable material of the panel.

Certain embodiments provide a method for coupling a panel to a mating structure. The method includes aligning a first hole defined in the panel with a second hole defined in the mating structure. The panel includes a deformable material. The method includes inserting a scrivet fastener into the first and second holes to couple the panel to the mating structure. The scrivet fastener includes a head, a shaft, and a compliant retention flange. The shaft extends from the head to a distal end of the shaft, and the compliant retention flange extends radially outward from the shaft and is axially spaced apart from the head. The scrivet fastener is inserted such that the compliant retention flange secures to the deformable material of the panel within the first hole and a distal section of the shaft secures to the mating structure within the second hole to couple the panel to the mating structure.

Certain embodiments provide a coupling assembly that includes a panel, a mating structure, and a plurality of scrivet fasteners. The panel includes a deformable material. The mating structure defines a plurality of holes that extend into the mating structure. The scrivet fasteners at least temporarily couple the panel to the mating structure. Each of the scrivet fasteners includes a head, a shaft extending from the head to a distal end of the shaft, and a compliant retention flange extending radially outward from the shaft and axially spaced apart from the head. The distal ends of the shafts are secured to the holes of the mating structure and the compliant retention flanges are secured to the deformable material of the panel.

### BRIEF DESCRIPTION OF THE DRAWINGS

FIG. 1 illustrates a conventional scrivet fastener used to secure a floor covering to production floor panels during a manufacturing process.

FIG. 2 is an isometric view of a scrivet fastener according to an embodiment of the present disclosure.

FIG. 3 is a cross-sectional view of the scrivet fastener of FIG. 2 being inserted into a hole of a panel according to an embodiment.

FIG. 4 is a cross-sectional view of a coupling assembly that includes the scrivet fastener, the panel, and a mating structure according to an embodiment.

FIG. 5 is an isometric view of the scrivet fastener according to a first alternative embodiment.

FIG. 6 is a side view of the scrivet fastener shown in FIG. 5.

FIG. 7 is an isometric view of the scrivet fastener according to a second alternative embodiment.

FIG. 8 is a flow chart of a method for coupling a panel to a mating structure according to an embodiment.

FIG. 9 is a first isometric view of a scrivet fastener according to an embodiment.

FIG. 10 is a second isometric view of the scrivet fastener shown in FIG. 9.

FIG. 11 is a side view of the scrivet fastener of FIG. 9.

FIG. 12 is a top-down plan view of the scrivet fastener of FIG. 9.

FIG. 13 is a bottom-up plan view of the scrivet fastener of FIG. 9.

### DETAILED DESCRIPTION OF THE DISCLOSURE

The foregoing summary, as well as the following detailed description of certain embodiments will be better understood when read in conjunction with the appended drawings. As used herein, an element or step recited in the singular and preceded by the word “a” or “an” should be understood as not necessarily excluding the plural of the elements or steps. Further, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular condition can include additional elements not having that condition.

Certain embodiments of the present disclosure provide a scrivet fastener for coupling a first object to a second object. For example, the scrivet fastener extends through respective holes in the first object and the second object. The holes align with each other when the first object is positioned against the second object. The scrivet fastener has a head that abuts against the first object, and a shaft of the scrivet fastener secures to the second object within the hole of the second object. The first object is captured or sandwiched between the head and the second object. Optionally, a plurality of the scrivet fasteners can be used to couple the same two objects, by providing local coupling at multiple different locations along the objects.

The scrivet fastener according to one or more embodiments establishes a reversible coupling interface between the first and second objects. For example, the scrivet fastener can be extracted from the holes of the first and second objects without damaging the scrivet fastener or the objects, such that the scrivet fastener is reusable. One application for the scrivet fastener is to provide temporary coupling between the objects, such as to secure the first object to the second object for only a designated period of time before the first object is separated from the second object, or before a more permanent means of coupling the two objects is performed.

The first object is referred to herein as a panel. The second object is referred to herein as a mating structure. The panel and mating structure can be represented by various different types of objects and materials. Optionally, the panel and the mating structure may be two panels that couple together, although the mating structure is not limited to being a panel. In one example, the mating structure is a production floor panel and the panel is a floor covering that protects the production floor panel, such as during manufacturing and/or renovation of an interior cabin or room. In another example, the panel may be a radiator shroud or cover and the mating structure is a frame of a vehicle or a radiator of the vehicle to which the radiator shroud is coupled. The panel, the mating structure, and the one or more scrivet fasteners represent a coupling assembly when the panel is coupled to the mating structure via the one or more scrivet fasteners.

FIG. 2 is an isometric view of a scrivet fastener 200 according to an embodiment. The scrivet fastener 200 includes a head 202, a shaft 204, and a compliant retention flange 206. The shaft 204 extends from the head 202 to a distal end 208 of the shaft 204. The shaft 204 is oriented about a central axis 210, such that the shaft 204 is elongated along the central axis 210. The shaft 204 in the illustrated embodiment has a cylindrical bearing surface 212 along a distal section 214 of the shaft 204. The cylindrical bearing surface 212 may have a uniform diameter along the length of the bearing surface 212. Optionally, the bearing surface 212 is smooth, or approximately smooth, such that the bearing surface 212 is free of protrusions, ridges, depressions, abrasive surface texture, and the like (ignoring minor manufacturing imperfections). The distal section 214 that includes the bearing surface 212 may extend fully to the distal end 208 of the shaft 204.

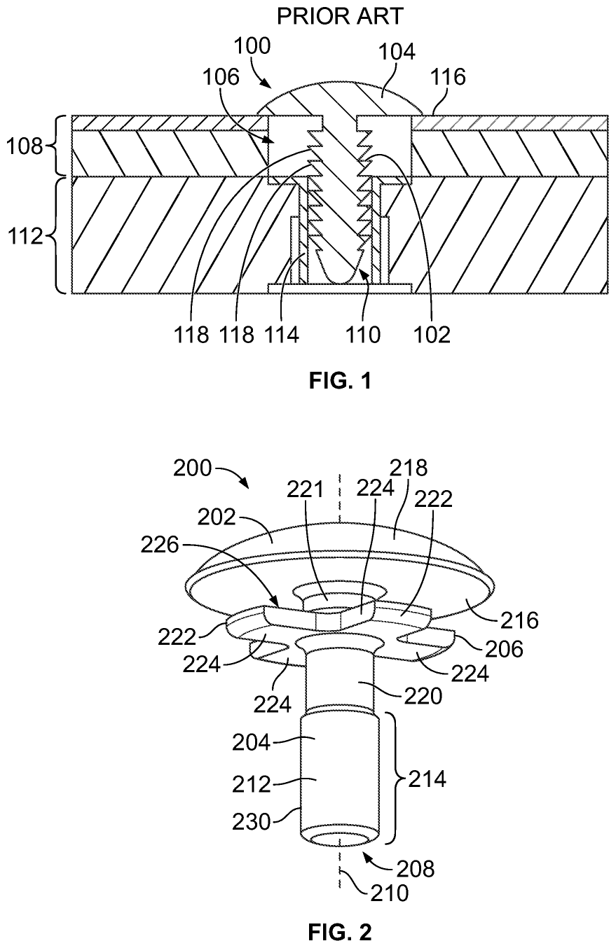

The head 202 of the scrivet fastener 200 has a panel-facing surface 216 and an outward-facing surface 218. The panel-facing surface 216 is also referred to herein as a lower surface 216, and the outward-facing surface 218 is referred to herein as an upper surface 218. The lower surface 216 may be flat and planar to provide a broad surface area for engaging a top surface of the panel (e.g., the top surface 116 of the cover panel 108 shown in FIG. 1) when the scrivet fastener 200 is fully loaded. The flat, planar lower surface 216 may also provide a contact surface for prying the scrivet fastener 200 out of the holes of the panel and the mating structure to extract the scrivet fastener 200. For example, a person may wedge a fingernail or a prying tool between the head 202 and the top surface 116 of the cover panel to exert a lifting force on the lower surface 216 of the head 202.

The upper surface 218 may be curved (e.g., rounded) to provide a comfortable surface for manually pushing the scrivet fastener 200 into the holes of the panel and the mating structure. The upper surface 218 may have a convex curvature that bulges outward in a direction away from the lower surface 216. In an alternative embodiment, the upper surface 218 may be generally planar with rounded edges and/or corners to provide manual comfort and reduce the risk of the fastener 200 snagging on objects that move along the panel and/or tripping people that walk along the panel (relative to fasteners with sharp corners and/or edges). The head 202 has a circular perimeter in the illustrated embodiment, but the perimeter of the head 202 may define another shape in an alternative embodiment, such as square or hexagonal.

The compliant retention flange 206 is attached to the shaft 204 and radially extends or projects outward from the shaft 204. The retention flange 206 is axially spaced apart from the head 202 along the central axis 210. For example, a spacer segment 221 of the shaft 204 is disposed between the head 202 and the retention flange 206. The retention flange 206 may be relatively thin and flat, having a disc-like shape. The retention flange 206 is compliant and deflectable. For example, the retention flange 206 may be deflectable in a proximal direction towards the head 202 and in a distal direction towards the distal end 208 of the shaft 204. In an embodiment, the retention flange 206 in a non-deflected, resting position radially extends from the shaft 204 within a flange plane, and the flange plane is perpendicular to the central axis 210, or approximately perpendicular (e.g., within 5 degrees or less of 90 degrees). The flange plane may be parallel, or approximately parallel (e.g., within 5 degrees or less of zero degrees), to a plane defined by the lower surface 216 of the head 202.

The compliant retention flange 206 secures the scrivet fastener 200 to the panel (e.g., the cover panel 108 shown in FIG. 1), which prohibits the scrivet fastener 200 from separating from the panel and becoming FOD. For example, the compliant retention flange 206 enters the hole defined by the panel, and a perimeter end 222 of the retention flange 206 engages material of the panel within the hole to secure the scrivet fastener 200 to the panel via that interference or friction fit.

In the illustrated embodiment, the retention flange 206 is segmented along a circumference of the flange 206 to define at least two flexible tabs 224 spaced apart from each other along the circumference of the flange 206. The tabs 224 are able to independently flex relative to one another. In one or more embodiments, the retention flange 206 incudes at least three flexible tabs 224 circumferentially spaced apart from one another by recesses 226 or notches. The at least three flexible tabs 224 radially project in different directions within the common flange plane, such that the tabs 224 are coplanar when in the non-deflected, resting position. The retention flange 206 has four tabs 224 in the illustrated embodiment. The four tabs 224 radially project in respective directions 90 degrees apart from the adjacent tabs 224. The four recesses 226 between the tabs 224 may have the same size and shape. As indicated above, the retention flange 206 may have other than four tabs 224, such as two tabs, three tabs, or at least five tabs. In another alternative embodiment, the retention flange 206 lacks discrete tabs, such that the retention flange 206 is a single flexible disc having a circular shape or another shape.

In an embodiment, the compliant retention flange 206 is axially spaced apart from the distal section 214 of the shaft 204 via a neck segment 220. The neck segment 220 is narrower than the distal section 214, at least slightly. For example, the neck segment 220 may be a cylindrical segment with a diameter that is between 5% and 35% less than a diameter of the cylindrical bearing surface 212 of the distal section 214. The neck segment 220 provides mechanical relief. For example, when forces are exerted on the head 202 that are not parallel to the central axis 210 while the distal section 214 is tightly held within a respective hole of the mating structure via a friction fit, the neck segment 220 may flex and/or bend, at least slightly, to accommodate the forces without damaging the scrivet fastener 200.

In one or more embodiments, the scrivet fastener 200 has a unitary, monolithic body 230. For example, the head 202, the shaft 204, and the retention flange 206 are seamlessly integrated together. In an embodiment, the scrivet fastener 200 may be formed via molding a plastic material. The head 202, the shaft 204, and the retention flange 206 may be composed of the same plastic material and may be formed during the same molding operation or a similar process to shape material into its final form.

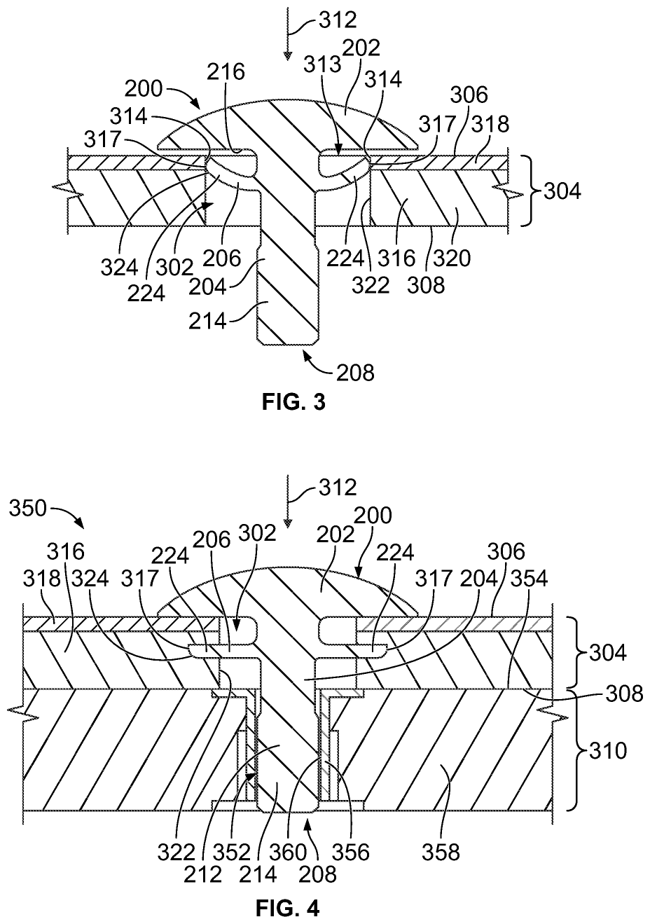

FIG. 3 is a cross-sectional view of the scrivet fastener 200 of FIG. 2 being inserted into a hole 302 of a panel 304 according to an embodiment. The panel 304 optionally may be the floor cover panel 108 shown in FIG. 1. The panel 304 has a thickness that extends from a top surface 306 to a bottom surface 308. The bottom surface 308 abuts against a surface of a mating structure 310 (shown in FIG. 4) when the scrivet fastener 200 couples the panel 304 to the mating structure 310. The top surface 306 may be exposed to the environment, such as the air in a cabin or room. The hole 302 extends through the full thickness of the panel 304 from the top surface 306 to the bottom surface 308. The hole 302 has a diameter that is greater than a diameter of the shaft 204 and less than a diameter of the head 202. The scrivet fastener 200 is inserted into the hole 302 in a loading direction 312 such that the distal end 208 of the shaft 204 passes the top surface 306 before passing the bottom surface 308. The shaft 204 is longer than the thickness of the panel 304. The distal section 214 of the shaft 204 projects beyond the bottom surface 308. The head 202 is too large to enter the hole 302, and remains above the top surface 306.

The diameter of the hole 302 may be at least slightly less than the diameter of the compliant retention flange 206, at least at or proximate to the upper surface 306. For example, the diameter of the retention flange 206 may be greater than the diameter of an opening 313 of the hole 302 at the upper surface 306. As a result, an edge 314 of the panel 304 that defines the opening 313 abuts against the compliant retention flange 206 and causes at least a portion of the retention flange 206 to deflect upon entering the hole 302. The retention flange 206 is forced to proximally deflect towards the head 202 as the fastener 200 is moved in the loading direction 312. When deflected, the tabs 224 of the retention flange 206 may remain physically separated from the lower surface 216 of the head 202 due to the axial spacing between the head 202 and the retention flange 206.

The scrivet fastener 200 reaches a fully loaded position when the lower surface 216 of the head 202 contacts and rests on the top surface 306 of the panel 304. When the scrivet fastener 200 is in the fully loaded position, the retention flange 306 is disposed within the hole 302 (e.g., is axially located between the top surface 306 and the bottom surface 308). The retention flange 306 secures to a deformable material 316 of the panel 304. For example, ends 317 of the flexible tabs 224 may at least partially dig into and embed within the deformable material 316 of the panel 304, which holds the scrivet fastener 200 in place on the panel 304.

In an embodiment, the panel 304 has at least two layers including a first layer 318 that defines the top surface 306 and a second layer 320 that is attached to the first layer 318. The second layer 320 includes the deformable material 316. The deformable material 316 may be include or represent foam, rubber, a rubber-like material, a relatively compliant polymer, or the like. The deformable material 316 may be designed to compress when a force is applied on the panel 304, and resiliently decompress when the force is removed. The first layer 318 may include a material that is harder (e.g., a greater durometer) and/or more rigid than the deformable material 316 in the second layer 320. For example, the material of the first layer 318 may by plastic, fiber-reinforced polymer, fiberglass, or the like. In an embodiment, the edge 314 of the first layer 318 forces the retention flange 206 to deflect as the shaft 204 is inserted into the panel 304. The ends 317 of the flexible tabs 224 may include curved and/or beveled edges 324, shown more clearly in FIG. 4, to provide lead-in surfaces that support deflection of the tabs 224 without stubbing. The curved edges 324 represent lower edges of the tabs 224 that engage the edge 314 of the panel 304.

Once the ends 317 of the retention flange 206 pass beyond (e.g., below) the first layer 318 to align with the second layer 320, the deformable material 316 allows the retention flange 206 to distally resile towards the undeflected state shown in FIG. 2. As the retention flange 206 resiles, the perimeter ends 222 penetrate an inner surface 322 of the deformable material 316 that defines the hole 302 to secure the scrivet fastener 200 to the panel 304, as shown in FIG. 4.

FIG. 4 is a cross-sectional view of a coupling assembly 350 that includes the scrivet fastener 200, the panel 304, and the mating structure 310 according to an embodiment. One or more of the scrivet fasteners 200 couples the panel 304 to the mating structure 310 to define an assembled state of the coupling assembly 350. The scrivet fastener 200 in FIG. 4 is in the fully loaded position.

To couple the panel 304 to the mating structure 310, the panel 304 is positioned next to the mating structure 310 such that the hole 302 of the panel 304 aligns with a hole 352 of the mating structure 310. The hole 302 of the panel 304 is referred to as a first hole 302, and the hole 352 of the mating structure 310 is referred to as a second hole 352. The bottom surface 308 of the panel 304 may be placed in contact with a top, panel-facing surface 354 of the mating structure 310. The scrivet fastener 200 is inserted into the holes 302, 352 by moving the scrivet fastener 200 relative to the panel 304 and mating structure 310 in the loading direction 312.

As the scrivet fastener 200 is inserted, the distal end 208 of the shaft 204 enters the second hole 352 after passing beyond the bottom surface 308 of the panel 304. Optionally, the second hole 352 is defined by an insert 356 that is attached to a body 358 of the mating structure 310. For example, the insert 356 has an annular shell with an inner surface 360 that defines the second hole 352. Alternatively, the mating structure 310 may lack the insert and the second hole is defined by an inner surface of the body 358 itself

The distal section 214 of the shaft 204 is formed based on the diameter of the second hole 352 such that the second hole 352 is only slightly larger than the diameter of the cylindrical bearing surface 212. The diameter of the second hole 352 may be larger than the diameter of the cylindrical bearing surface 212 by a designated tolerance or clearance range. The tolerance range may be between 0.1 mm and 3 mm, depending on the sizes of the components and design considerations. As a result, the second hole 352 accommodates the distal section 214 of the shaft 204 without damaging the distal section 214. Within the second hole 352, due to the narrow clearance, there is a substantial amount of surface area of the cylindrical bearing surface 212 in contact with the inner surface 360 of the insert 356 that defines the second hole 352. The surface-to-surface contact friction-fit couples the scrivet fastener 200 to the mating structure 310.

When in the fully loaded position illustrated in FIG. 4, the distal section 214 of the shaft 204 secures the scrivet fastener 200 to the mating structure 310 via the friction-fit coupling interface within the second hole 352. The head 202 abuts the top surface 306 of the panel 304 to sandwich and retain the panel 304 between the head 202 and the mating structure 310. The scrivet fastener 200 couples the panel 304 to the mating structure 310 by trapping the panel 304 between the head 202 and the mating structure 310. The retention flange 206 is disposed within the first hole 302. The tabs 224 are no longer deflected by the harder, first layer 318 of the panel 304, so the ends 317 of the tabs 224 are permitted to penetrate the inner surface 322 of the deformable material 316. The engagement between the tabs 224 of the retention flange 206 and the deformable material 316 secures the scrivet fastener 200 to the panel 304, independent of the mating structure 310. For example, even if the panel 304 is pulled away from the mating structure 310 with sufficient force to extract the distal section 214 of the shaft 204 from the second hole 352, the retention flange 206 retains the scrivet fastener 200 on the panel 304.

The coupling assembly 350 in FIG. 4 shows a single scrivet fastener 200 extending through a hole 302 in the panel 304 and into a hole 352 in the mating structure 310 that aligns with the hole 302 in the panel 304. The coupling assembly 350 may include a plurality of scrivet fasteners 200 that are copies or replicas of the illustrated scrivet fastener 200. Each of the scrivet fasteners 200 extends through a different set of holes 302, 352 in the panel 304 and the mating structure 310 to secure the panel 304 to the mating structure 310 at multiple different coupling locations. For example, the coupling assembly 350 may include dozens or hundreds of the scrivet fasteners 200 to at least temporarily secure the panel 304 to the mating structure 310.

The coupling assembly 350 can be utilized to provide efficient, temporary coupling between a panel and a mating structure in various different use applications. One possible use case is to temporarily secure a cover panel on top of production floor panels within a cabin of a vehicle or a room of a building. For example, the panel 304 may be a cover panel, and the mating structure 310 may be one or more production floor panels. The cover panel 304 protects the production floor panels 310 from stains, spills, abrasions, dents, dings, and the like, while the cabin and/or room is being manufactured, renovated, or repaired. After the work is completed, the cover panel 304 can be removed from the floor panels 310 by extracting the scrivet fasteners 200 one at a time or by lifting up on the cover panel 304. For example, an operator may lift an edge of the cover panel 304 such that the top surface 306 of the cover panel 304 applies sufficient force on the head 202 of the scrivet fastener 200 in a direction away from the floor panel 310 to overcome the friction fit coupling of the shaft 204 in the hole 352 of the floor panel 310. The shaft 204 of the scrivet fastener 200 is lifted out of the hole 352. Removing the shaft 204 from the hole 352 may emit a popping sound that indicates that the scrivet fastener 200 is uncoupled from the floor panel 310. This process of lifting the cover panel 304 may successfully and efficiently remove a plurality of the scrivet fasteners 200 from the floor panels 310 without damaging the fasteners 200 or the floor panels 310. Furthermore, the retention flanges 206 retain the fasteners 200 on the cover panel 304, without the fasteners 200 forming projectiles of debris (e.g., FOD) as the cover panel 304 is lifted off the floor panels 310. As such, once the cover panel 304 is removed from the floor panels 310, the operator can then simply and easily push or pry the scrivet fasteners 200 out of the holes 302 of the cover panel 304 and collect the scrivet fasteners 200 in a container for future use.

In an embodiment, the coupling assembly 350 is used in an interior cabin of an aircraft while the interior cabin is being manufactured to protect the floor panels 310 during the manufacturing operation. The cover panel 304 is removed from the floor panels 310 prior to the aircraft going into service. Alternatively, instead of an aircraft, embodiments of the coupling assembly 350 may be used with various other types of vehicles, such as automobiles, buses, trucks, rail vehicles, watercraft, spacecraft, and the like. The coupling assembly 350 can also be used off-board vehicles, such as within buildings and on equipment.

The coupling assembly 350 may be used to couple a variety of objects together, and is not limited to the specific use case of floor protection covers described above. For example, the coupling assembly 350 may be used to couple a shroud or cover of a radiator to a frame or radiator of a vehicle. In this example, the radiator shroud may represent the panel 304, and the vehicle frame or radiator may represent the mating structure 310.

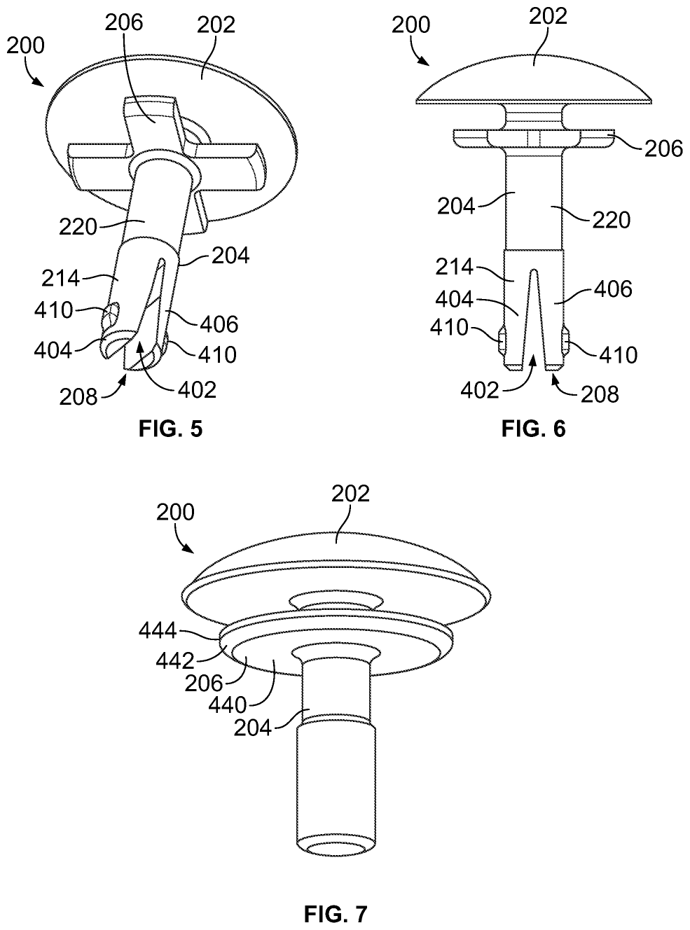

FIG. 5 is an isometric view of the scrivet fastener 200 according to a first alternative embodiment. FIG. 6 is a side view of the scrivet fastener 200 shown in FIG. 5. The scrivet fastener 200 has the same head 202 and compliant retention flange 206 as the scrivet fastener 200 shown in FIGS. 2 through 4. The distal section 214 of the shaft 204 in the illustrated embodiment is bifurcated or forked. For example, a wedge-shaped slot 402 is defined between a first tine 404 and a second tine 406 of the shaft 204. The distal end 208 of the shaft 204 is defined by the ends of the first and second tines 404, 406. The size of the slot 402 tapers with increasing proximity to the neck segment 220 of the shaft 204. The slot 402 enables the tines 404, 406 to deflect towards one another, to reduce the diameter of the distal section 214, when the shaft 204 is inserted into the second hole 352 of the mating structure 310.

The distal section 214 may include at least one detent feature that is a protrusion or a depression along the outer surface of the shaft 204. In the illustrated embodiment, the distal section 214 has two detent features 410 that are protrusions. One of the detent features 410 is disposed on the first tine 404, and the other detent feature 410 is on the second tine 406. The detent features 410 may be disposed proximate to the distal end 208 of the shaft 204. As the shaft 204 is inserted into the hole 352 of the mating structure 310, the protruding detent features 410 contact the edge of the hole 352 at the opening. The contact interface forces the tines 404, 406 to deflect towards each other within the wedge-shaped slot 402. The deflected tines 404, 406 exert a resilient normal force against the inner surface of the hole 352, which secures the fastener 200 to the mating structure 310. Optionally, the mating structure 310 may include complementary detent features that interface with the detent features 410 of the shaft 204 to enhance the retention force between the fastener 200 and the mating structure 310. In the illustrated embodiment, the complementary detent features in the mating structure 310 may be depressions or grooves that are sized and positioned to receive the detent protrusions 410 therein when the scrivet fastener 200 achieves the fully loaded position. In an alternative embodiment, the detent features on the shaft 204 may be depressions or grooves, and the complementary detent features in the mating structure 310 may be protrusions or annular ribs/ridges that are received into the depressions or grooves.

FIG. 7 is an isometric view of the scrivet fastener 200 according to a second alternative embodiment. The scrivet fastener 200 in FIG. 7 has the same head 202 and shaft 204 as the scrivet fastener 200 shown in FIGS. 2 through 4. The compliant retention flange 206 differs from the retention flange 206 in FIGS. 2 through 6 because the flange 206 does not include multiple flexible tabs separated by recesses (or cutouts). The retention flange 206 in the illustrated embodiment is a thin, circular disc 440. The disc 440 is flexible to deflect upon entering the hole 302 in the panel 304, similar to the tabs 224 of the flange 206 shown in FIG. 3. The disc 440 may have a curved edge 442 at a perimeter end 444 of the disc 440, which functions as a lead-in surface similar to the curved edges 324 of the tabs 224. The perimeter end 444 of the disc 440 may extend into the deformable material 316 of the panel 304 when the scrivet fastener 200 is in the fully loaded position to secure the scrivet fastener 200 to the panel 304, similar to the scrivet fastener 200 shown in FIG. 4. Optionally, the disc 440 represents the retention flange 206 shown in FIGS. 2 through 6 formed without the recesses 226 that define the tabs 224.

The scrivet fastener 200 according to other embodiments may include combinations of the embodiments described herein. For example, a third alternative embodiment of the scrivet fastener 200 may have the bifurcated distal segment 214 shown in FIGS. 5 and 6 with the disc-shaped retention flange 206 shown in FIG. 7. The distal section of the scrivet fastener 200 in another embodiment may include the detent features 410 of FIGS. 5 and 6 without being bifurcated.

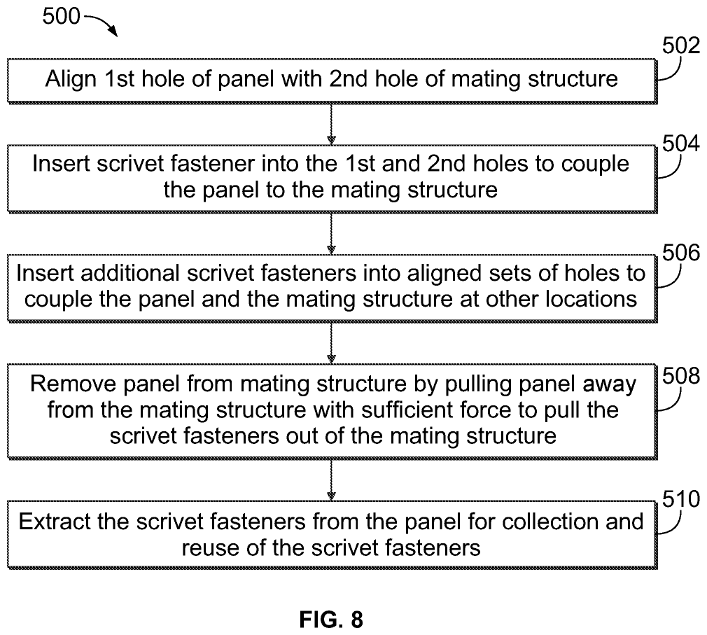

FIG. 8 is a flow chart 500 of a method for coupling a panel to a mating structure according to an embodiment. The method may include more steps, fewer steps, and/or different steps than shown in the flow chart 500. Furthermore, the steps of the method may be performed in a different order than the chronological order presented in FIG. 8 unless specified. The method includes, at step 502, aligning a first hole 302 defined in a panel 304 with second hole 352 defined in a mating structure 310. The panel 304 includes a deformable material 316.

At step 504, a scrivet fastener 200 is inserted into the first and second holes 302, 352 to couple the panel 304 to the mating structure 310, at least temporarily. The scrivet fastener 200 includes a head 202, a shaft 204, and a compliant retention flange 206. The shaft 204 extends from the head 202 to a distal end 208 of the shaft 204. The compliant retention flange 206 extends radially outward from the shaft 204 and is axially spaced apart from the head 202. The scrivet fastener 200 is inserted such that the shaft 204 and the compliant retention flange 206 are received within the first hole 302 of the panel 304, and the compliant retention flange 206 engages the deformable material 316 of the panel 304 within the first hole 302. Optionally, the retention flange 206 has a diameter greater than a diameter of the first hole 302 in the panel 304, and inserting the scrivet fastener 200 causes at least a portion of the retention flange 206 to deflect towards the head 202 upon entering the first hole 302. As the scrivet fastener 200 moves to a fully loaded position, the retention flange 206 is permitted to move distally from the deflected state and engage (e.g., penetrate) an inner surface 322 of the deformable material 316 to secure the scrivet fastener 200 to the panel 304.

The scrivet fastener 200 is inserted such that a distal section 214 of the shaft 204 is received into the second hole 352 of the mating structure 310. The distal section 214 secures to the mating structure 310 to couple the panel 304 to the mating structure 310. The distal section 214 may include a cylindrical bearing surface 212, and the scrivet fastener 200 is inserted such that the cylindrical bearing surface 212 friction-fit couples to an inner surface 360 of the mating structure 310. The inner surface 360 defines the second hole 352.

In an embodiment, the scrivet fastener 200 is one of a plurality of scrivet fasteners. At step 506, a second scrivet fastener 200 (as needed) of the scrivet fasteners is inserted into a second set of holes defined in the panel 304 and the mating structure 310, which align with each other. The second set may include a third hole that is defined in the panel 304, and a fourth hole that is defined in the mating structure 310. The second scrivet fastener 200 is inserted into the second set of holes to couple the panel 304 to the mating structure 310 at a location spaced apart from the first scrivet fastener 200. The insertion steps 504 and 506 can be repeated until there is enough installed fasteners 200 to sufficiently couple the panel 304 to the mating structure 310.

At step 508, to remove the panel 304 from the mating structure 310, the panel 304 is pulled away from the mating structure 310 such that a force exerted by the panel 304 on the head 202 of each scrivet fastener 200 pulls the distal section 214 of the respective shaft 204 out of the second hole 352 of the mating structure 310. For example, the force exerted on the panel 304 in a direction away from the mating structure 310 has at least a threshold magnitude that overcomes the retention forces between the distal sections 214 of the shafts 204 and the second holes 352 of the mating structure 310. The panel 304 may be pulled up from an edge and/or corner, such that only one or a few scrivet fasteners 200 are disconnected from the mating structure 310 at a time as the portion of the panel 304 uncoupled from the mating structure 310 progressively increases. When the scrivet fasteners 200 separate from the mating structure 310, the panel 304 is effectively uncoupled from the mating structure 310. In an embodiment, the scrivet fasteners 200 remain secured to the panel 304 due to the compliant retention flanges 206.

At step 510, the scrivet fastener 200 is extracted from the first hole 302 of the panel 304 by exerting a removal load on the scrivet fastener 200 that deflects the compliant retention flange 206 without damaging the scrivet fastener 200. When the scrivet fasteners 200 are disconnected from the panel 304, the fasteners 200 can be collected in a container and saved for future use. For example, one scrivet fastener 200 that is removed from a first panel and a first mating structure and be reused to couple a second panel to a second mating structure. The shaft 204 of that scrivet fastener 200 can be inserted into a first hole in the second panel and a second hole in the second mating structure. The compliant retention flange secures to a deformable material of the second panel, and the distal section (e.g., distal end) of the shaft 204 secures to the second mating structure within the second hole. The scrivet fasteners 200 according to the embodiments described herein are reusable, simple to install and uninstall, provide satisfactory retention to the mating structure 310 to avoid unintentional uncoupling of the panel 304 from the mating structure 310, and avoid contributing to FOD.

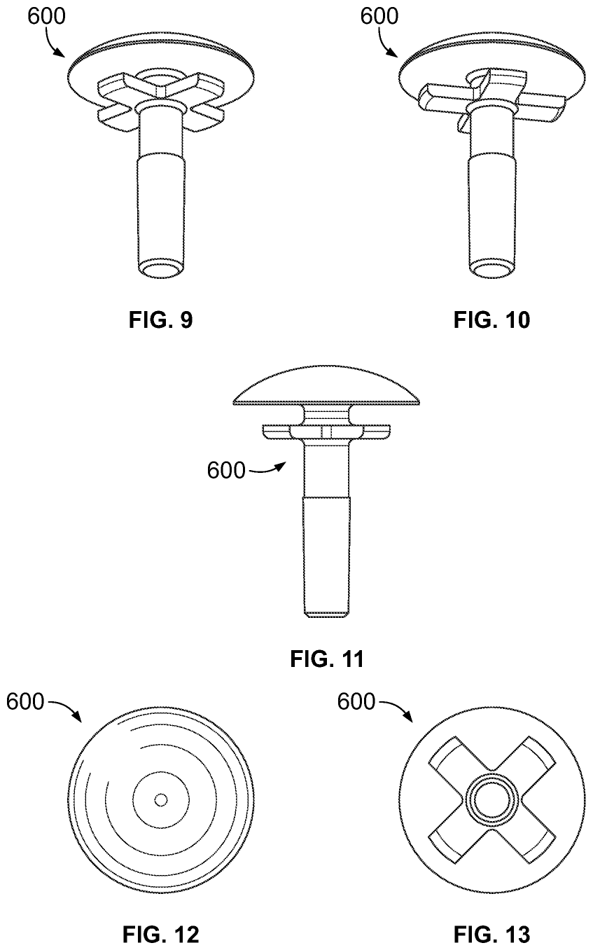

FIG. 9 is a first isometric view of a scrivet fastener 600 according to an embodiment. FIG. 10 is a second isometric view of the scrivet fastener 600 shown in FIG. 9. FIG. 11 is a side view of the scrivet fastener 600 of FIG. 9. FIG. 12 is a top-down plan view of the scrivet fastener 600 of FIG. 9. FIG. 13 is a bottom-up plan view of the scrivet fastener 600 of FIG. 9.

Clause 1: A scrivet fastener for coupling a panel to a mating structure, the scrivet fastener comprising:

a head;

a shaft extending from the head to a distal end of the shaft; and

a compliant retention flange extending radially outward from the shaft and axially spaced apart from the head,

wherein the scrivet fastener is configured to at least temporarily couple the panel to the mating structure, such that the distal end of the shaft is secured to a hole of the mating structure and the compliant retention flange is secured to a deformable material of the panel.

Clause 2. The scrivet fastener of Clause 1, wherein a distal section of the shaft has a cylindrical bearing surface configured to friction fit couple to the mating structure within the hole.

Clause 3. The scrivet fastener of Clause 1 or Clause 2, wherein a distal section of the shaft includes at least one detent feature.

Clause 4. The scrivet fastener of any of Clauses 1-3, wherein a distal section of the shaft is bifurcated.

Clause 5. The scrivet fastener of any of Clauses 1-4, wherein the shaft includes a neck section axially disposed between a distal section of the shaft and the compliant retention flange, the neck section being narrower than the distal section.

Clause 6. The scrivet fastener of any of Clauses 1-5, wherein the shaft and the compliant retention flange are configured to be received within a panel hole defined by the panel, the compliant retention flange having a diameter greater than a diameter of an opening of the panel hole to cause at least a portion of the compliant retention flange to deflect upon entering the panel hole.

Clause 7. The scrivet fastener of any of Clauses 1-6, wherein the compliant retention flange includes at least two flexible tabs circumferentially spaced apart from one another for engaging with the deformable material of the panel.

Clause 8. The scrivet fastener of Clause 7, wherein the compliant retention flange includes at least three flexible tabs radially projecting in different directions within a common plane.

Clause 9. The scrivet fastener of Clause 7 or Clause 8, wherein each of the at least two flexible tabs comprises a curved edge at an end of the flexible tab.

Clause 10. The scrivet fastener of any of Clauses 7-9, wherein each of the at least two flexible tabs is deflectable towards the head when inserting the scrivet fastener to secure the panel to the mating structure.

Clause 11. The scrivet fastener of any of Clauses 1-10, wherein the head, the shaft, and the compliant retention flange are comprised of a unitary, monolithic body.

Clause 12. A method for coupling a panel to a mating structure, the method comprising:

aligning a first hole defined in the panel with a second hole defined in the mating structure, the panel comprising a deformable material; and

inserting a scrivet fastener into the first and second holes to couple the panel to the mating structure, the scrivet fastener including a head, a shaft, and a compliant retention flange, the shaft extending from the head to a distal end of the shaft, the compliant retention flange extending radially outward from the shaft and axially spaced apart from the head,

wherein the scrivet fastener is inserted such that the compliant retention flange secures to the deformable material of the panel within the first hole and a distal section of the shaft secures to the mating structure within the second hole to couple the panel to the mating structure.

Clause 13. The method of Clause 12, wherein the scrivet fastener is a first scrivet fastener of a plurality of scrivet fasteners, and the method comprises inserting a second scrivet fastener of the plurality of scrivet fasteners into a third hole defined in the panel and a fourth hole defined in the mating structure to couple the panel to the mating structure at a location spaced apart from the first scrivet fastener.

Clause 14. The method of Clause 12 or Clause 13, further comprising pulling the panel away from the mating structure such that a force exerted by the panel on the head of the scrivet fastener pulls the distal section of the shaft out of the second hole of the mating structure to uncouple the panel from the mating structure such that the scrivet fastener remains attached to the panel via the compliant retention flange being secured to the deformable material.

Clause 15. The method of Clause 14, further comprising extracting the scrivet fastener from the first hole of the panel by exerting a removal load on the scrivet fastener that deflects the compliant retention flange to unsecure the compliant retention flange from the deformable material of the panel without permanently damaging the scrivet fastener.

Clause 16. The method of Clause 15, further comprising inserting the scrivet fastener into a first hole of a second panel and a second hole of a second mating structure to couple together the second panel and the second mating structure.

Clause 17. The method of any of Clauses 12-16, wherein inserting the scrivet fastener comprises friction-fit coupling a cylindrical bearing surface of the distal section of the shaft to an inner surface of the mating structure that defines the second hole.

Clause 18. A coupling assembly comprising:

a panel that includes a deformable material;

a mating structure that defines a plurality of holes that extend into the mating structure; and

a plurality of scrivet fasteners that at least temporarily couple the panel to the mating structure, each of the scrivet fasteners comprising:
a head;
a shaft extending from the head to a distal end of the shaft; and
a compliant retention flange extending radially outward from the shaft and axially spaced apart from the head,

wherein the distal ends of the shafts are secured to the holes of the mating structure and the compliant retention flanges are secured to the deformable material of the panel.

Clause 19. The coupling assembly of Clause 18, wherein the mating structure is a floor panel within an internal cabin of a vehicle, and the panel is a floor cover.

Clause 20. The coupling assembly of Clause 18 or Clause 19, wherein, when a pulling force is exerted on the panel in a direction away from the mating structure with at least a threshold magnitude, the distal ends of the scrivet fasteners exit the holes of the mating structure, and the compliant retention flanges remain secured to the deformable material of the panel.

While various spatial and directional terms, such as top, bottom, lower, mid, lateral, horizontal, vertical, front and the like can be used to describe embodiments of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

As used herein, approximating value modifiers such as “about,” “substantially,” “generally,” and “approximately” inserted before a numerical value indicate that the value can represent other values within a designated threshold range above and/or below the specified value without resulting in a change in the basic function to which it may be related. Accordingly, a value modified by a term or terms, such as “about,” “substantially,” “generally,” and “approximately,” may be not to be limited to the precise value specified. The approximating terms may indicate inclusion of values within a designated threshold margin of the precise value. The threshold margin may be plus/minus 3% of the precise value, plus/minus 5% of the precise value, plus/minus 10% of the precise value, or the like. Two items or axes that are generally parallel can be angled within 3 degrees of each other in one example, within 5 degrees of each other in a second example, and within 10 degrees of each other in a third example.

It is to be understood that the above description is intended to be illustrative, and not restrictive. For example, the above-described embodiments (and/or aspects thereof) can be used in combination with each other. In addition, many modifications can be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are exemplary embodiments. Many other embodiments will be apparent to those of skill in the art upon reviewing the above description. The scope of the various embodiments of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A scrivet fastener for coupling a panel to a mating structure, the scrivet fastener comprising:
a head;
a shaft extending from the head to a distal end of the shaft; and
a compliant retention flange extending radially outward from the shaft and axially spaced apart from the head,
wherein the scrivet fastener is configured to at least temporarily couple the panel to the mating structure, such that the distal end of the shaft is secured to a hole of the mating structure and the compliant retention flange is secured to a deformable material of the panel.

2. The scrivet fastener of claim 1, wherein a distal section of the shaft has a cylindrical bearing surface configured to friction fit couple to the mating structure within the hole.

3. The scrivet fastener of claim 1, wherein a distal section of the shaft includes at least one detent feature.

4. The scrivet fastener of claim 1, wherein a distal section of the shaft is bifurcated.

5. The scrivet fastener of claim 1, wherein the shaft includes a neck section axially disposed between a distal section of the shaft and the compliant retention flange, the neck section being narrower than the distal section.

6. The scrivet fastener of claim 1, wherein the shaft and the compliant retention flange are configured to be received within a panel hole defined by the panel, the compliant retention flange having a diameter greater than a diameter of an opening of the panel hole to cause at least a portion of the compliant retention flange to deflect upon entering the panel hole.

7. The scrivet fastener of claim 1, wherein the compliant retention flange includes at least two flexible tabs circumferentially spaced apart from one another for engaging with the deformable material of the panel.

8. The scrivet fastener of claim 7, wherein the compliant retention flange includes at least three flexible tabs radially projecting in different directions within a common plane.

9. The scrivet fastener of claim 7, wherein each of the at least two flexible tabs comprises a curved edge at an end of the flexible tab.

10. The scrivet fastener of claim 7, wherein each of the at least two flexible tabs is deflectable towards the head when inserting the scrivet fastener to secure the panel to the mating structure.

11. The scrivet fastener of claim 1, wherein the head, the shaft, and the compliant retention flange are comprised of a unitary, monolithic body.

12. A method for coupling a panel to a mating structure, the method comprising:
aligning a first hole defined in the panel with a second hole defined in the mating structure, the panel comprising a deformable material; and
inserting a scrivet fastener into the first and second holes to couple the panel to the mating structure, the scrivet fastener including a head, a shaft, and a compliant retention flange, the shaft extending from the head to a distal end of the shaft, the compliant retention flange extending radially outward from the shaft and axially spaced apart from the head,
wherein the scrivet fastener is inserted such that the compliant retention flange secures to the deformable material of the panel within the first hole and a distal section of the shaft secures to the mating structure within the second hole to couple the panel to the mating structure.

13. The method of claim 12, wherein the scrivet fastener is a first scrivet fastener of a plurality of scrivet fasteners, and the method comprises inserting a second scrivet fastener of the plurality of scrivet fasteners into a third hole defined in the panel and a fourth hole defined in the mating structure to couple the panel to the mating structure at a location spaced apart from the first scrivet fastener.

14. The method of claim 12, further comprising pulling the panel away from the mating structure such that a force exerted by the panel on the head of the scrivet fastener pulls the distal section of the shaft out of the second hole of the mating structure to uncouple the panel from the mating structure such that the scrivet fastener remains attached to the panel via the compliant retention flange being secured to the deformable material.

15. The method of claim 14, further comprising extracting the scrivet fastener from the first hole of the panel by exerting a removal load on the scrivet fastener that deflects the compliant retention flange to unsecure the compliant retention flange from the deformable material of the panel without permanently damaging the scrivet fastener.

16. The method of claim 15, further comprising inserting the scrivet fastener into a first hole of a second panel and a second hole of a second mating structure to couple together the second panel and the second mating structure.

17. The method of claim 12, wherein inserting the scrivet fastener comprises friction-fit coupling a cylindrical bearing surface of the distal section of the shaft to an inner surface of the mating structure that defines the second hole.

18. A coupling assembly comprising:
a panel that includes a deformable material;
a mating structure that defines a plurality of holes that extend into the mating structure; and
a plurality of scrivet fasteners that at least temporarily couple the panel to the mating structure, each of the scrivet fasteners comprising:
a head;
a shaft extending from the head to a distal end of the shaft; and
a compliant retention flange extending radially outward from the shaft and axially spaced apart from the head,
wherein the distal ends of the shafts are secured to the holes of the mating structure and the compliant retention flanges are secured to the deformable material of the panel.

19. The coupling assembly of claim 18, wherein the mating structure is a floor panel within an internal cabin of a vehicle, and the panel is a floor cover.

20. The coupling assembly of claim 18, wherein, when a pulling force is exerted on the panel in a direction away from the mating structure with at least a threshold magnitude, the distal ends of the scrivet fasteners exit the holes of the mating structure, and the compliant retention flanges remain secured to the deformable material of the panel.
